(19) United States
(12) Patent Application Publication
(10) Pub. No.: US 2006/0135728 A1
(43) Pub. Date: Jun. 22, 2006

(54) Thermoplastic polyurethanes and use thereof

(75) Inventors: Henricus Peerlings, Solingen (DE); Wolfgang Kaufhold, Koln (DE); Gunther Stollwerck, Krefeld (DE); Robert Hubertus Van Mullekom, Lokeren (BE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/300,122

(22) Filed: Dec. 14, 2005

(30) Foreign Application Priority Data
Dec. 17, 2004 (DE) 102004060799.0

(51) Int. Cl. C08G 18/10

(52) U.S. Cl. 528/59

(57) ABSTRACT

The present invention relates to thermoplastic polyurethane molding compositions. These thermoplastic polyurethanes exhibit good adhesion to glass due to the presence of the required silanes. This invention also relates to the production of glass composites and solar cell modules from these novel thermoplastic polyurethanes.

### CROSS REFERENCE TO RELATED PATENT APPLICATION

The present patent application claims the right of priority under 35 U.S.C. §119 (a)-(d) of German Patent Application No. 10 2004 060 799.0, filed Dec. 17, 2004.

### BACKGROUND OF THE INVENTION

The present invention relates to thermoplastic polyurethanes which exhibit good adhesion to glass, and to the production of composites and solar cell modules from these thermoplastic polyurethanes.

Thermoplastic polyurethanes (TPU) are of great industrial significance due to their good elastomer properties and melt processability. A review of the production, properties and applications of TPU is provided in, for example, Kunststoff Handbuch [G. Becker, D. Braun], volume 7 “Polyurethane”, Munich, Vienna, Carl Hanser Verlag, 1983.

TPU are usually synthesized from linear polyols (e.g. macrodiols), such as polyester, polyether or polycarbonate diols, organic diisocyanates and short-chain, usually difunctional alcohols (i.e. chain extenders). TPU may be produced either continuously or discontinuously. The best known production processes are the belt process as described in, for example, GB-A 1 057 018, and the extruder process as described in, for example, DE-A 19 64 834.

The synthesis of the melt-processable polyurethane elastomers may proceed either stepwise (i.e. a prepolymer dispensing process), or by the simultaneous reaction of all components in a single stage (i.e. a one-shot dispensing process).

The problem of adhesion arises when thermoplastic polyurethane is used in a composite with glass. For this reason, silanes are frequently used in order to improve the adhesion to glass.

U.S. Pat. No. 4,718,956 describes an octadecyltriethoxysiiane which is suitable for temporary adhesion of TPU to glass.

WO 2004/054113 describes the use of difunctional silanes which may be incorporated into TPU.

Silanes may also be grafted onto TPU such as is described, for example, in WO 00/75213 or by S. Dassin et al., Polymer Eng. Sci., 2002, 42(8), 1724-1739.

However, grafting silanes onto TPU or incorporating silanes into TPU may, disadvantageously, modify the extrusion characteristics and material properties of the TPU.

Thus, an object of the present invention was to provide TPUs which have good adhesion to glass (even after storage and/or weathering), which simultaneously exhibit good extrusion quality, and moreover, do not yellow on storage or weathering.

It has been possible to achieve this object by the inclusion of specific silanes into TPUs.

### SUMMARY OF THE INVENTION

The present invention relates to thermoplastic polyurethanes. These thermoplastic polyurethanes comprise the reaction product of:

a) one or more organic diisocyanate components; with

b) at least one isocyanate-reactive component having a number average molecular weight of 450 to 10,000 g/mol and having, on average, at least about 1.8 to at most about 3.0 Zerewitinoff-active hydrogen atoms; and

c) one or more chain extenders having a molecular weight of 60 to 400 g/mol and, on average, from about 1.8 to about 3.0 Zerewitinoff-active hydrogen atoms;

in the presence of:

d) from about 0.05 to about 5 wt. %, based on 100 wt. % of the thermoplastic polyurethane, of at least one silane which corresponds to the general structural formula I:

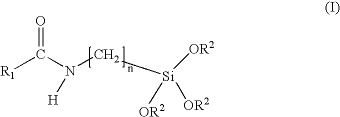

wherein:
n represents an integer of from 1 to 12;
R¹ represents NHR³ in which R³ represents a hydrogen atom, an alkyl radical having 1 to 20 carbon atoms, an aryl radical having 1 to 20 carbon atoms or an aralkyl radical having 1 to 20 carbon atoms; or OR⁴ in which R⁴ represents a hydrogen atom, an alkyl radical having 1 to 20 carbon atoms, an aryl radical having 1 to 20 carbon atoms or an aralkyl radical having 1 to 20 carbon atoms; and
R² represents an alkyl radical having 1 to 20 carbon atoms, an aryl radical having 1 to 20 carbon atoms, or an aralkyl radical having 1 to 20 carbon atoms;

e) optionally, one or more catalysts;

f) from about 0.1 to about 10 wt. %, based on 100 wt. % of the thermoplastic polyurethane, of one or more light stabilizers;

g) optionally, one or more additives and/or auxiliary substances; and

h) optionally, one or more chain terminators;

wherein the molar ratio of isocyanate groups of a) to isocyanate-reactive groups of b), c) and optionally h) is 0.9:1 to 1.1:1.

### DETAILED DESCRIPTION OF THE INVENTION

Suitable organic diisocyanates to be used as component a) in accordance with the present invention may include, for example, the aliphatic, cycloaliphatic, araliphatic, heterocyclic and aromatic diisocyanates, such as are described in, for example, Justus Liebigs Annalen der Chemie, 562, pages 75 to 136.

The following compounds are specifically disclosed as suitable examples: suitable aliphatic diisocyanates include compounds such as ethylene diisocyanate, 1,4-tetramethylene diisocyanate, 1,12-dodecane diisocyanate, 1,6-hexamethylene diisocyanate; suitable cycloaliphatic diisocyanates include compounds such as isophorone diisocyanate, 1,4-cyclohexane diisocyanate, 1-methyl-2,4-cyclohexane diisocyanate, 1-methyl-2,6-cyclohexane diisocyanate and the corresponding isomer-mixtures, 4,4′-,2,4′- and 2,2′-dicyclohexylmethane diisocyanate and the corresponding isomer mixtures; and suitable aromatic diisocyanates include compounds such as 2,4- and 2,6-toluene diisocyanate, mixtures of 2,4- and 2,6-toluene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and/or 2,4′-diphenylmethane diisocyanates, 4,4′-diisocyanato-1,2-diphenylethane and 1,5-naphthylene diisocyanate. Aliphatic and/or cycloaliphatic diisocyanates are preferably used in accordance with the present invention.

More specifically, 1,4-cyclohexane diisocyanate, 1,6-hexamethylene diisocyanate, isophorone diisocyanate and dicyclohexylmethane diisocyanate are particularly preferred isocyanates for the present invention. These diisocyanates may be used either individually or in the form of mixtures with one another. They may also be used together with up to 15 mol% (calculated relative to total diisocyanate) of a polyisocyanate. However, the polyisocyanate may be added at most in such a quantity that a product which is still melt-processable is obtained.

Suitable compounds to be used as chain extenders, i.e. component c) in accordance with the present invention, typically have a molecular weight of 60 to 400. In addition, it is preferred that the compounds used as chain extenders have, on average, from about 1.8 to about 3.0 Zerewitinoff-active hydrogen atoms. Compounds containing Zerewitinoff-active hydrogen atoms include, for example, compounds which contain amino groups, thiol groups, carboxyl groups, or hydroxyl groups. It is preferred that these are hydroxyl groups. Thus, the preferred chain extenders for the present invention are those having two to three, and more preferably two, hydroxyl groups.

As set forth above, one or more compounds selected from the aliphatic diols which contain from 2 to 14 carbon atoms is/are preferably used as the chain extender, i.e. component c). Such compounds include, for example, ethanediol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Diesters of terephthalic acid with glycols having 2 to 4 carbon atoms are, however also suitable. Some examples of such compounds include terephthalic acid bis-ethylene glycol and terephthalic acid bis-1,4-butanediol, hydroxyalkylene ethers of hydroquinone such as, for example, 1,4-di(β-hydroxyethyl)hydroquinone, ethoxylated bisphenols such as, for example, 1,4-di(β-hydroxyethyl)bisphenol A, (cyclo)aliphatic diamines such as, for example, isophoronediamine, ethylendiamine, 1,2-propylenediamine, 1,3-propylenediamine, N-methyl-1,3-propylenediamine, N,N′-dimethylethylene-diamine, aromatic diamines such as, for example, 2,4-toluenediamine, 2,6-toluenediamine, 3,5-diethyl-2,4-toluenediamine and 3,5-diethyl-2,6-toluenediamine and primary mono-, di-, tri- or tetraalkyl-substituted 4,4′-diaminodiphenylmethanes. Particularly preferred compounds to be used as chain extenders are ethanediol, 1,4-butanediol, 1,6-hexanediol, 1,4-di(β-hydroxyethyl)hydroquinone or 1,4-di(β-hydroxyethyl)bisphenol A. Smaller quantities of triols may additionally be used.

Suitable compounds to be used as component b) in accordance with the present invention include those compounds which have, on average, at least about 1.8 to at most about 3.0 Zerewitinoff-active hydrogen atoms. Compounds containing Zerewitinoff-active hydrogen atoms include, for example, compounds which contain amino groups, thiol groups, carboxyl groups, or hydroxyl groups. It is preferred that these are hydroxyl groups. Thus, the preferred compounds for component b) of the present invention are those having two to three, and more preferably two, hydroxyl groups. In accordance with the invention, these compounds typically have number average molecular weights \overline{M}ₙ of 450 to 10,000. It is preferred that these compounds have number average molecular weights \overline{M}_{N} of from about 450 to about 6000, and more preferably have number average molecular weights \overline{M}ₙ of from about 600 to about 4500. Examples of such compounds include, but are not limited to, polyesters, polyethers and/or polycarbonates comprising hydroxyl groups, together with polyesteramides or mixtures thereof.

Suitable polyether diols to be used as component b) of the present invention may be produced by, for example, reacting one or more alkylene oxides having 2 to 4 carbon atoms in the alkylene residue with a starter molecule which contains two (or more) active hydrogen atoms in bound form. Alkylene oxides which may be mentioned by way of example include: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably used. The alkylene oxides may be used individually, alternately in succession or as mixtures. Suitable starter molecules include compounds such as, for example, water; aminoalcohols, such as N-alkyl-diethanolamines, for example N-methyl-diethanolamine; and diols such as ethylene glycol, 1,3-propylene glycol, 1,4-butanediol and 1,6-hexanediol. Mixtures of starter molecules may optionally also be used. Suitable polyetherols additionally include the hydroxyl group-containing polymerization products of tetrahydrofuran. Trifunctional polyethers may also be used in proportions of about 0 to about 30 wt. %, based on the wt. of the difunctional polyether. The maximum amount of trifunctional polyether is that quantity which results in a final product that is still melt-processable. The substantially linear polyether diols used as component b) herein preferably have number average molecular weights \overline{M}ₙ of 450 to 6000. These may be used both individually and in the form of mixtures with one another.

Suitable polyester diols include, for example, those produced from dicarboxylic acids having 2 to 12 carbon atoms, preferably 4 to 6 carbon atoms, and polyhydric alcohols. Dicarboxylic acids which are may be suitable, for example include compounds such as: aliphatic dicarboxylic acids such as succinic acid, glutaric acid, adipic acid, suberic acid, azelaic acid and sebacic acid; or aromatic dicarboxylic acids, such as phthalic acid, isophthalic acid and terephthalic acid. The dicarboxylic acids may be used individually or as mixtures such as, for example in the form of a mixture of succinic, glutaric and adipic acids. For the production of polyester diols, it may optionally be advantageous, instead of using dicarboxylic acids, to use the corresponding dicarboxylic acid derivatives such as, for example, carboxylic acid diesters having 1 to 4 carbon atoms in the alcohol residue, carboxylic anhydrides or carboxylic acid chlorides. Examples of suitable polyhydric alcohols include glycols with 2 to 10, preferably 2 to 6 carbon atoms, such as, for example, ethylene glycol, diethylene glycol, 1,4-butanediol, 1,5-pentanediol, 1,6-hexanediol, 1,10-decanediol, 2,2-dimethyl-1,3-propanediol, 1,3-propanediol or dipropylene glycol. Depending upon the desired properties, the polyhydric alcohols may be used alone or as a mixture with one another. Esters of carbonic acid with the stated diols are also suitable, and particularly, those having 4 to 6 carbon atoms, such as 1,4-butanediol or 1,6-hexanediol; condensation products of ω-hydroxycarboxylic acids, such as ω-hydroxycaproic acid or polymerisation products of lactones, for example optionally substituted ω-caprolactones. Preferred polyester diols include ethanediol polyadipates, 1,4-butanediol polyadipates, ethanediol/1,4-butanediol polyadipates, 1,6-hexanediol/neopentyl glycol polyadipates, 1,6-hexanediol/1,4-butanediol polyadipates and polycaproplactones. The polyester diols may have number average molecular weights \overline{M}ₙ of from about 450 to about 10,000, and may be used either individually or in the form of mixtures with one another.

Compounds which are monofunctional towards isocyanates as suitable to be used as chain terminators, i.e. component h), in accordance with the present invention. These chain terminators may, preferably, be used in proportions of up to 2 wt. %, based on 100 wt. % of the TPU. Suitable compounds include, for example, monoamines such as butyl- and dibutylamine, octylamine, stearylamine, N-methylstearylamine, pyrrolidine, piperidine or cyclohexylamine; monoalcohols such as butanol, 2-ethylhexanol, octanol, dodecanol, stearyl alcohol, the various amyl alcohols, cyclohexanol and ethylene glycol monomethyl ether, etc..

In accordance with the present invention, the relative quantities of the Zerewitinoff-active compounds, i.e. components b), c) and h), are preferably selected such that the ratio of the sum of isocyanate groups, in component a), to the sum of Zerewitinoff-active hydrogen atoms, in components b), c) and h), ranges from about 0.9:1 to about 1.1:1.

The thermoplastic polyurethane elastomers according to the invention may additionally contain up to about 10 wt. %, based on 100 wt. % of the TPU, of one or more conventional auxiliary substances and additives, i.e. component g). Typical auxiliary substances and additives include, but are not limited to, slip agents and mold release agents, such as fatty acid esters, the metal soaps thereof, fatty acid amides, fatty acid ester amides and silicone compounds, plasticizers, anti-blocking agents, inhibitors, stabilizers against hydrolysis, heat and discoloration, dyes, pigments, inorganic and/or organic fillers, fungistatically and bacteriostatically active substances together with fillers and mixtures thereof.

Further details concerning the above described auxiliary substances and additives may be found in the literature. In particular, details are disclosed in, for example the monograph by J. H. Saunders and K. C. Frisch “High Polymers”, volume XVI, “Polyurethane”, parts 1 and 2, Verlag Interscience Publishers 1962 and 1964 respectively, or ”Taschenbuch für Kunststoff-Additive” by R. Gachter and H. Müller (Hanser Verlag Munich 1990) or DE-A 29 01 774.

Suitable light stabilizers for component f) of the present invention are preferably UV stabilizers, antioxidants and/or HALS (hindered amine light stabilizers) compounds. Additional details concerning suitable light stablizers may be found in the literature and are described in, for example, H. Zweifel, “Plastics Additives Handbook”, 2001, 5th ed., Carl Hanser Verlag, Munich.

Suitable compounds to be used in as the silanes, i.e. component d) herein, or mixtures thereof are described below. The silanes may be used in a quantity of from about 0.05 to about 5 wt. %, based on 100 wt. % of the TPU. Suitable compounds to be used as silanes herein are those which correspond to the following structural formula I:

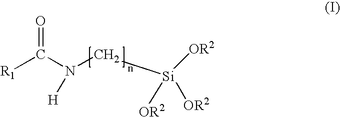

wherein:
n represents an integer of from 1 to 12;
R¹ represents either NHR³ in which R³ represents a hydrogen atom, an alkyl radical having 1 to 20 carbon atoms, an aryl radical having 1 to 20 carbon atoms or an aralkyl radical having 1 to 20 carbon atoms; or OR⁴ in which R⁴ represents a hydrogen atom, an alkyl radical having 1 to 20 carbon atoms, an aryl radical having 1 to 20 carbon atoms or an aralkyl radical having 1 to 20 carbon atoms; and
R² represents an alkyl radical having 1 to 20 carbon atoms, an aryl radical having 1 to 20 carbon atoms or an aralkyl radical having 1 to 20 carbon atoms.

The following may be mentioned as examples which are suitable for component d) herein: e.g. Silquest A 1524 from GE Toshiba Silicones. Silquest A 1524 is a silane corresponding to the above formula in which R¹ represents NH₂, R² represents CH₃ and n=3.

The silane may be added to the TPU both during production of the TPU, and in an additional process step, as well as during compounding or on extrusion.

Additional additives which may be incorporated into the TPU include thermoplastics such as, for example, polycarbonates and acrylonitrile/-butadiene/styrene (ABS) terpolymers, and preferably ABS. Other elastomers such as rubber, ethylene/vinyl acetate copolymers, styrene/butadiene copolymers and other TPUs may also be used.

Suitable catalysts to be used as component e) in accordance with the present invention include, for example, the tertiary amines which are known and conventional and described in the prior art. Some examples of tertiary amines include compounds such as, for example, triethylamine, dimethylcyclohexyl-amine, N-methylmorpholine, N,N′-dimethylpiperazine, 2-(dimethylaminoethoxy)-ethanol, diazabicyclo[2.2.2]octane, etc. as well as organic metal compounds such as, for example, titanic acid esters, iron compounds or tin compounds such as, for example, tin diacetate, tin dioctoate, tin dilaurate or the dialkyltin salts of aliphatic carboxylic acids such as dibutyltin diacetate or dibutyltin dilaurate or other similar compounds. Preferred catalysts are the organic metal compounds, and particular are the titanic acid esters, iron, tin, zirconium and bismuth compounds. In accordance with the present invention, the total quantity of catalysts in the TPU according to the invention preferably amounts to 0 to 5 wt. %, and more preferably 0 to 2 wt. %, based on 100 wt. % of the TPU.

The auxiliary substances and additives may be added in accordance with the present invention during the production process and/or they may be incorporated into the TPU in an additional compounding step or extrusion process.

The thermoplastic polyurethanes of the present invention are suitable for the production of composites with glass, and in particular, for the production of solar cell modules.

For the production of a composite comprising a thermoplastic polyurethane and glass a sheet or film of thermoplastic polyurethane is placed onto a sheet of glass; it is heated whereby the composite is formed. The inventive thermoplastic polyurethane is used to form the sheet or film.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

The following components were used in the working examples below:
Polyester A polyesterdiol with a molecular weight of Mₙ=2000 g/mol;

commercially available from Bayer MaterialScience AG
HDI 1,6-hexamethylene diisocyanate
HDO 1,6-hexanediol
BDO 1,4-butanediol
Irganox 1010 an antioxidant; commercially available from Ciba Specialty Chemicals GmbH
Tinuvin 328 a benzotriazole-based light stabilizer; commercially available from Ciba Specialty Chemicals GmbH
DBTL dibutyltin dilaurate
Silquest A-1100 3-aminopropyltriethoxysilane; a silane commercially available from GE Toshiba Silicones
Silquest A-137 octyltriethoxysilane; a silane commercially available from GE Toshiba Silicones
Silquest Y-11597 tris-(3-(trimethoxysilyl)propyl) isocyanurate; a silane commercially available from GE Toshiba Silicones
Silquest A-1524 ureidopropyltrimethoxysilane; a silane commercially available from GE Toshiba Silicones
   Production of the TPU in the Form of a Sheet

A mixture of 1075 g of Polyester A, 109 g of HDO, 13.5 g of BDO, 0.5 wt. %, based on 100 wt. % of TPU, of Irganox 1010 and approx. 60 ppm of DBTL (relative to the quantity of polyol) was heated up to 130° C. while being stirred with a paddle stirrer at a rotational speed of 500 revolutions per minute (rpm), whereupon 271 g of HDI were added. Stirring was continued until the maximum possible increase in viscosity, after which the TPU was discharged. Finally, the material was subjected to thermal post-treatment for 30 minutes at 80° C. and then pelletised. The appropriate amount of the various silanes (see Table for details of silanes and respective amounts) was then applied onto the pellets by drum coating. The silane coated pellets were then injection molded to form sheets with a thickness of 2 mm.

Production of the Solar Module:

Each of the TPU sheets produced as described above was first of all laid onto a low iron content, white glass sheet having a thickness of 4 mm and dimensions of 12×12 cm. A monocrystalline silicon solar cell was laid on top, followed by a second TPU sheet and, finally, a 180 μm gauge polyvinyl fluoride film (i.e. Tedlar Icosolar 2442 from Isovolta AG). This module was laid with the glass sheet facing downwards in a vacuum laminator and heated to 155° C. The module was then evacuated for 5 minutes and pressed for 6 minutes.

Damp Heat Test:

Each of the solar modules produced as described above were subjected to the damp heat test according to standard IEC 61215, with the exception that measurement was performed at 80° C. instead of 85° C. After specific time intervals, qualitative testing was performed on each of the solar modules to determine (i) whether adhesion was still effective, (ii) whether the material had yellowed and (iii) whether degradation of the TPU had occurred (as determined by measuring solution viscosity).

Determination of Solution Viscosity:

99.7 g of N-methyl-2-pyrrolidone were weighed out with 0.1 wt. % dibutylamine and 0.4 g of TPU. Each of the samples were stirred on a magnetic stirrer.

The samples were dissolved at approx. 70° C. for approx. 1 hour and left to stand overnight at room temperature.

The samples and a blank sample (i.e. pure solvent) were measured at 25° C. using a Schott viscosity measuring station.

Relative solution viscosity is the ratio of the viscosity of the particular sample relative to the blank sample.

The Schott viscosity measuring station consists of:

AVS 400 viscosity measuring station, ASV/S measurement stand, glass constant-temperature bath, model 50110 Ubbelohde viscosimeter

Determination of Yellowness Index:

The yellowness index was determined on each of the test specimens using a Minolta CR-100 Chroma Meter.

The yellowness index was determined in accordance with DIN 6167.

The instrument was always recalibrated before each series of measurements. After triggering the measurement flash, the display had to show the values noted on the reverse of the white calibration sheet.

| | | |
|---|---|---|
| 91.1 | 317 | 335 |
| Y | x | y |

With other pairs of values, the instrument must be calibrated in accordance with the manufacturer's instructions. The reference yellowness index (YI) of the calibration plate is 3.75.

The yellowness index (YI) was calculated according to the following equation:

$$YI = \frac{( {2.45}^{*} \times - 1.149 )}{y} + 1.149 * 100$$

The yellowness index was measured by laying each of the test specimens on the white ceramic reference sheet in such a manner that the central zones (of the test specimen and the reference sheet) lie over one another. The measurement flash was then triggered.

The x and y values were read off and the yellowness index (YI) was calculated in accordance with the above formula. The results are shown in the following Table.

TABLE
Results

| | | Initial value | | | after 500 hours | | | after 1000 hours | | | after 1750 hours | | |
|---|---|---|---|---|---|---|---|---|---|---|---|---|---|
| Example | Silane | SV | YI | Delam. | SV | YI | Delam. | SV | YI | Delam. | SV | YI | Delam. |
| 1 (comp.) | Silquest A-1100, 1 wt. % | 1.276 | 3.2 | 0 | n.d. | 6.2 | 0 | 1.087 | 6.1 | 0 | n.d. | 6.2 | 0 |
| 2 (comp.) | Silquest A-137, 0.3 wt. % | 1.283 | 2.9 | 66 | 1.258 | 3.8 | 100 | n.d. | n.d. | 100 | n.d. | n.d. | 100 |
| 3 (comp.) | Silquest Y-11597, 0.5 wt. % | 1.27 | 6 | 0 | n.d. | n.d. | n.d. | 1.149 | 5.9 | 10 | n.d. | n.d. | n.d. |
| 4 (inv.) | Silquest A-1524, 1 wt. % | 1.275 | 2.2 | 0 | n.d. | 2.9 | 0 | n.d. | 3.2 | 0 | 1.222 | 3.7 | 0 |

SV: relative solution viscosity
YI.: yellowness index
Delam.: delaminated surface area in % after damp heat test
n.d.: not determined

An aminosilane was used in Comparative Example 1. The corresponding TPU exhibited considerable, unacceptable yellowing.

In Comparative Examples 2 and 3, the solar module exhibited delamination in the damp heat test.

A silane in accordance with the present invention was used in Example 4. A weather-resistant, unyellowed and undelaminated glass composite was obtained from this Example.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Thermoplastic polyurethanes comprising the reaction product of
a) one or more organic diisocyanate components; with
b) at least one isocyanate-reactive component having a number average molecular weight of 450 to 10,000 g/mol and, on average, at least 1.8 to at most 3.0 Zerewitinoff-active hydrogen atoms; and
c) one or more chain extenders having a molecular weight of 60 to 400 g/mol and, on average, from about 1.8 to about 3.0 Zerewitinoff-active hydrogen atoms;
in the presence of
d) 0.05 to 5 wt. %, based on the 100 wt. % of the thermoplastic polyurethane, of at least one silane which corresponds to the general structural formula I: 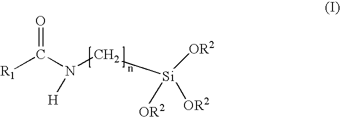
wherein:
n represents an integer of from 1 and 12;
R¹ represents NHR³ in which R³ represents a hydrogen atom, an alkyl radical having 1 to 20 carbon atoms, an aryl radical having 1 to 20 carbon atoms, or an aralkyl radical having 1 to 20 carbon atoms; or OR⁴ in which R⁴ represents a hydrogen atom, an alkyl radical having 1 to 20 carbon atoms, an aryl radical having 1 to 20 carbon atoms or an aralkyl radical having 1 to 20 carbon atoms;
and
R² represents an alkyl radical having 1 to 20 carbon atoms, an aryl radical having 1 to 20 carbon atoms or an aralkyl radical having 1 to 20 carbon atoms;
e) optionally, one or more catalysts;
f) 0.1 to 10 wt. %, based on 100 weight % of the thermoplastic polyurethane, of one or more light stabilizers;
g) optionally, one or more additives and/or auxiliary substances; and
h) optionally, one or more chain terminators;
wherein the molar ratio of isocyanate groups of a) to isocyanate-reactive groups of b), c) and optionally h) is from about 0.9:1 to about 1.1:1.

2. The thermoplastic polyurethane of claim 1, wherein a) said organic diisocyanate component comprises one or more aliphatic diisocyanates and/or one or more cycloaliphatic diisocyanates.

3. In a process for the production of a composite comprising a thermoplastic polyurethane and glass, comprising placing a sheet of thermoplastic polyurethane onto a sheet of glass, and applying heat, the improvement wherein the thermoplastic polyurethane comprises the thermoplastic polyurethane of claim 1.

4. In a process for the production of a solar cell module, comprising placing a sheet of a thermoplastic polyurethane onto a sheet of glass, placing a solar cell onto the exposed side of the thermoplastic polyurethane, placing a second sheet of a thermoplastic polyurethane onto the exposed side of the solar cell, placing a sheet of film onto the exposed side of the second sheet of the thermoplastic polyurethane, and applying heat; the improvement wherein one or both sheets of thermoplastic polyurethane comprises the thermoplastic polyurethane of claim 1.
